(19) United States
(12) Patent Application Publication
(10) Pub. No.: US 2002/0098469 A1
(43) Pub. Date: Jul. 25, 2002

(54) EXTRACORPOREAL METHODS FOR ENHANCING ANTIGEN PRESENTATION AND IMMUNE RESPONSIVENESS

(75) Inventor: RICHARD L. EDELSON, WESTPORT, CT (US)

Correspondence Address: MORGAN LEWIS & BOCKIUS LLP, 1111 PENNSYLVANIA AVENUE NW, WASHINGTON, DC, 20004, US

(73) Assignee: morgan ,lewis, bockius llp

(21) Appl. No.: 09/014,705

(22) Filed: Jan. 28, 1998

Related U.S. Application Data
(63) Continuation-in-part of application No. 08/621,109, filed on Mar. 22, 1996.
Application No. 08/621,109 is a 371 of international application No. PCT/WO97/34472, filed on Mar. 18, 1997.

(51) Int. Cl. A01N 1/02; A01N 63/00; A01N 65/00

(52) U.S. Cl. 435/2

(57) ABSTRACT

Methods are provided to enhance the expression on certain disease-effector cells of MHC peptides and/or the amount of disease-associated antigens presented by such MHC peptides. These methods relate to certain incubation times for such cells following photopheresis treatment and also relate to appropriate incubation containers. Overall, these methods enhance a subject's immune response to disease-associated antigens expressed, for example, by clonal T-cell or B-cell malignancies and in T-cell or B-cell mediated autoimmune disorders.

This application is a continuation-in-part of U.S. application Ser. No. 08/621,109, filed Mar. 22, 1996, and a continuation-in-part of PCT Application No. WO97/34472 filed Mar. 18, 1997, the disclosures of which are hereby incorporated by reference.

### FIELD OF THE INVENTION

The invention relates to extracorporeal methods for enhancing a subject's immune response to disease-associated antigens that are bound to and presented by major histocompatibility complex (MHC) Class I or MHC Class II glycoproteins on certain disease effector cells. Specifically, these methods enhance the cell-surface expression of these MHC peptides and/or the amount of disease-associated antigens presented by such MHC peptides. In particular, the invention relates to methods that enhance a subject's immune response to disease-associated antigens expressed by clonal T-cell or B-cell malignancies and in T-cell or B-cell mediated autoimmune disorders.

### BACKGROUND OF THE INVENTION

In traditional photopheresis, a patient ingests a light-activatable drug, such as a psoralen, and, after a short period of time, is connected to a machine that withdraws a quantity of blood in a manner similar to kidney dialysis. Alternatively, the light-activatable drug is administered directly into the tubing leading to the machine. This machine, which is about the size of a dishwasher, separates the blood into red blood cells, white blood cells, and plasma. The white blood cells, bathed in plasma, are irradiated with ultraviolet light within the machine before being recombined with the other native blood components and returned to the patient. Typically, this recombined blood is reinfused within about two hours of its removal from the patient.

A greatly preferred photoactivatable agent in this procedure is 8-methoxypsoralen (“8-MOP”), which is well-known as a treatment for a variety of skin diseases and lymphomas. The capsule formulation of 8-MOP is marketed under the name Oxsalen®, and the liquid formulation is marketed under the name UVADEX®. The pharmacologic agent is activated by the ultraviolet light to form a transiently energized, bifunctional alkylating agent capable of photomodifying cellular DNA and proteins to form photoadducts. U.S. Pat. Nos. 4,321,919 (1982); 4,398,906 (1983); 4,428,744 (1984); 4,464,166 (1984); and 4,683,889 (1987), all issued to Edelson, describe photopheresis methods for treating the blood of a diseased subject where disease-producing white blood cells, such as lymphocytes, have been naturally stimulated and/or expanded as a consequence of the disease state, either as an immunologically reactive state or a malignancy.

Rapidly expanding disease-effector cell clones, for example, T-cell clones, are preferentially damaged, including those responsible for clone-specific immune responses. This damage occurs through two primary molecular mechanisms. First, the 8-MOP forms either monoadducts with pyrimidine bases of DNA, or cross-links between complementary strands of the DNA. Interference with transcription of the affected genes, or blockage of cell division, ensures, ultimately leading to programmed cell death or apoptosis. Second, 8-MOP binds to proteins, largely through the formation of covalent links with aromatic amino acids, including tyrosines. The altered proteins are then identified by intracellular policing molecules, including ubiquitin, and targeted for catabolic destruction, much of which occurs in the proteasomes. The degraded proteins generate large amounts of peptides, many of which are transported into the endoplasmic reticulum, where they enter the antigen-presenting pathway. In this way, large numbers of antigenic peptides are transported by histocompatibility proteins, particularly of Class I, to the cell surface, where they can be recognized by immunologically competent cells, such as CD4⁺ and CD8⁺ T cells.

A very special property of the photoactivatable drugs which cause these effects is the degree to which their activity can be controlled or titrated. For example, 8-MOP is biologically inert in its resting state, but can be transiently (for millionths of a second) activated by long-wave ultraviolet energy. It is only this activated form which causes the above-mentioned covalent bonds. Hence, the level of activity of 8-MOP can be titrated more effectively than non-photoactivatable drugs. For this reason, it is possible to titrate the activity of 8-MOP to a level of activity permitting between only one and six photoadducts per million base pairs of DNA and an equally limited number of bonds to cytoplasmic proteins. In this way, a special window of opportunity is opened for the augmented presentation of antigens at the cell surface: apoptosis (which would interfere with antigen processing and presentation) does not discernibly start for about one day, while the targeted proteins are being degraded and shipped to the surface in the context of Class I and other such histocompatibility molecules. It is largely the ensuing immune response, directed against antigens on the disease-effector cells, such as a disease-causing lymphocyte, that leads to the beneficial effects of this therapy.

Photopheresis also differs from conventional methods of pharmacological alteration of the immune response, since it appears to have no lasting effect on general immune system competence. Following extracorporeal irradiation, the damaged lymphocytes are returned to the subject. The damaged lymphocytes are cleared from the patient's system, presumably for a combination of reasons, such as the disruption of cell membrane integrity and alteration of the DNA or protein within the cells. Such methods are thereby effective to reduce selected populations of blood constituents.

The use of extracorporeal photochemotherapy (i.e., “photopheresis”) for the treatment of cutaneous T cell lymphoma (CTCL), presently available at over 100 centers around the world, was described by Edelson in the late 1980s. See, e.g., New England J. Med. (1987) 316:297-303; Sci. Amer. (1988) 256(8):68-75; Annals of N.Y. Acad. of Sciences (1991) 636:154-164. In the case of CTCL, photopheresis therapy results in selective destruction of the malignant T cell clone. It is believed that exposure of as little as five percent of the members of the malignant T cell clone to the 8-MOP/irradiation treatment, followed by return of the irradiated, damaged cells to the subject, elicits a specific response to the aberrant T cells that is mediated by idiotypic epitopes of the T cell surface receptors that are specific for whatever antigen that T cell would otherwise recognize. In other words, the damaged cells of the malignant clone in effect act as a vaccine to prime the immune system to specifically destroy the untreated remainder of the aberrant clone.

The results of a variety of clinical studies suggest that photopheresis also may be beneficial in several other T-cell mediated autoimmune disorders and T-cell mediated diseases, including pemphigus vulgaris, lupus erythematosus, multiple sclerosis, scleroderma, rheumatoid arthritis, graft-versus-host disease, rejection of transplanted heart, lung and kidney allografts and in HIV infection. See, e.g., Slovis et al., New England J. Med. (1995) 332:962 (Correspondence).

More recently, it was discovered that current agents used in photopheretic methods to induce an immune response against one or more target antigens (for example, tumor-specific antigens of the tumor cell clone in CTCL), are effective because they increase the level of MHC expression in the disease effector cells. They also enhance the transport of disease-associated antigens to the surface of the disease effector cells as antigens that are weakly bound to MHC molecules.

The use of dendritic cells to generate a primary immune response itself is presently a significant area of clinical inquiry. For example, it is expected that dendritic cells might provide a way to “kick-start” therapeutic immunity. To treat a cancer, a sample of the patient's peripheral blood cells will be cultured in vitro under conditions that amplify the number and proportion of dendritic cells. These cells will then be mixed with tumor-specific antigen(s) in the form of peptides, proteins, cDNAs, or even mRNAs encoding the antigens, with the aim of loading peptides from a tumor-specific antigen onto the dendritic cells' MHC molecules. When infused back into the patient, these cells should stimulate a primary cytotoxic-T-lymphocyte (CTCL) response against the tumor antigen and may promote tumor regression. Repeat infusions might then reinforce the immune reaction and generate a strong therapeutic effect.

With respect to photopheresis, it is also known that photopheretic methods can be substantially improved by adding dendritic cells, or other antigen presenting cells, to the treated blood prior to reinfusion, and isolated and cultured dendritic cells can be used to boost a subject's immune system response in most situations where an immune system response in desired. See, e.g., Edelson, PCT Application Serial No. WO97/34472 (1997). The antigen presenting cells also may be exposed to the photoactive agent and an appropriate light source either separately from or together with disease-effector cells.

The present invention is based in part on the observation that incubating the disease-effector cells for about 20-24 hours following 8-MOP/UVA treatment substantially increases the level of MHC Class I molecules expressed on the treated cells. Further, the level of antigen present in association with those Class I molecules also is substantially increased. When dendritic cells, or other antigen presenting cells, are added to the photopheresed cells during this incubation period, the photopheresed disease-effector cells are able to transfer enhanced amounts of disease-associated antigens to these dendritic cells. Based on these observations, the present invention provides improved photopheresis methods.

Although PCT Application Serial No. WO97/34472, filed by the present inventor, describes an overnight incubation of photopheresed cells, none of the other references discussed above suggests an extended incubation time for extracorporeal blood treatment methods. Accordingly, there is still a need for improved methods of enhancing the efficacy of existing photopheretic methods to induce an enhanced immune response to disease-associated antigens.

II. The Presence of Plasticizers in Blood Storage Devices

Plasticized polyvinylchloride (PVC) has been used to manufacture blood storage bags for more than 45 years. Carmen, Transfus. Med. Rev. (1993) 7(1):1-10. The plasticizer component makes the plastic more flexible. Such bags are useful for the storage and treatment of blood products because they are relatively transparent, hard to break, can be sealed aseptically and can be centrifuged for the isolation of various blood components. However, the most commonly-used plasticizer, di-(2-ethylhexyl)pthalate or DEHP, has been shown to leach from the plastic when it comes into contact with biological fluids and be converted to its principal metabolite, mono(2-ethylhexyl)phthalate or MEHP. Labow et al., Environ. Health Perspect. (1990) 89:189-193; Shneider et al., New England J. Med. (1989) 320:1563 (Letter to the Editor); Rock et al., Environ. Health Perspect. (1986) 65:309-16.

Studies have reported that DEHP has a membrane stabilizing effect that prolongs the storage time of red blood cells. Myhre, Ann. Clin. Lab. Sci. (1988) 18(2):131-140; and AuBuchon et al., Blood (1988) 71(2):448-452. However, other effects of DEHP and MEHP are toxic and may include carcinogenicity. Griffiths et al., Ann. Clin. Lab. Sci. (1985) 15(2):140-151. For example, MEHP was shown to have a hypertensive effect on the pulmonary vasculature ending in constriction and edema, Labow (1990, above); and platelet reactivity was better maintained in storage bags manufactured without DEHP. Racz et al., Orv. Hetil. (1993) 134(29):1581-1586. Also, a dose-dependent suppressive effect on the respiratory burst capacity of leukocytes by MEHP has been reported. Mettang et al., Nieren-Hochdruckkr (1997) 26(Supp. 1):S7-S12. Anti-plasticizer specific IgE has been found in the serum of transfused patients who reacted to a platelet or packed red cell transfusion, although the patients' reactions could not be attributed to presence of this antibody. Salkie et al., J. Clin. Invest. Med. Dec. (1995) 18: 419-423.

Various alternative formulations have been developed for blood, dialysis and IV bags and associated tubing. These include di-n-decyl phthalate plasticized PVC, Shimizu et al., Transfusion (1989) 29(4):292-297; and flexible polyolefin extruded in multiple layers, Leaversuch, Modern Plastics (1996) 26(9):34. Because of the concerns noted above, plasticizer-free blood and IV bags have recently become available. Medical Materials Update (1997) 4(3).

One such blood bag is manufactured by the Fenwal® Division of Baxter Healthcare Corp., under the name Amicus™ Apheresis Kit. Various patents describe plasticizer-free blood bags, including Shang et al., U.S. Pat. No. 5,683,768 (1997) and Patel et al., U.S. Pat. No. 5,167,657 (1992).

The present invention is based in part on the observation that incubating disease-effector cells in a plasticizer-free blood bag substantially increases, by up to or exceeding about three-fold, the level of MHC Class I molecules expressed on the treated cells. Based on these observations, the present invention provides additional, improved photopheresis methods.

### SUMMARY OF THE INVENTION

The present invention relates to a method to enhance the level of expression of MHC molecules, such as Class I and Class II molecules, on the cell membrane of cells withdrawn from a subject. The steps in this method include treating the cells with a photoactivatable agent for a sufficient time to allow the agent to enter the cells, photoactivating the agent contained within the cells, and incubating the cells for at least about eight hours during which time the effects of photoactivated agent are manifested in the treated cell population. Ultimately, the treated cells are reinfused into the patient or mammalian subject from which they were withdrawn.

Another aspect of the invention relates to a method to enhance the level of expression of at least one disease-associated antigen on the cell membrane of cells withdrawn from a subject, where the antigen is bound to or closely associated with MHC molecules on the cell membrane. The steps in this method include treating the cells with a photoactivatable agent for a sufficient time to allow the agent to enter the cells, photoactivating the agent contained within the cells, and incubating the cells for at least about eight hours. Ultimately, the treated cells are reinfused into the patient or mammalian subject from which they were withdrawn.

In another aspect of the present invention, the incubation period is about 8 to about 30 hours, more preferably about 20 to about 26 hours and most preferably about 22 to 24 hours.

The invention methods are useful in treating cells that comprise populations of disease-effector cells, which in some cases are leukocytes, such as T-cells, B-cells and macrophages. Diseases which result in the presence of such cells as disease-effector cells include lymphoma and, in particular, cutaneous T-cell lymphoma.

In another of its aspects, the invention involves improving a patient's immune response to at least one disease-associated antigen bound by or associated with the MHC molecules on the disease-effector cells. Such antigens include viral antigens, bacterial antigens, transplant antigens and tumor specific antigens. In the case of cutaneous T-cell lymphoma, for example, the disease-associated antigen is a tumor specific antigen, particularly a peptide derived from a T cell antigen-binding cell surface receptor. Transplant antigens include those antigens found in the tissues of a donor that are considered foreign by the immune system of the recipient of those tissues when and the recipients immune system mounts a response that would cause damage or lead to the rejection of the transplanted tissue.

In yet a further aspect of the invention, the photoactivatable agent is 8-MOP is a preferred photoactivating agent.

Another aspect of the invention relates to the use of containers for withdrawn leukocyte populations that does not leach substantial amounts of toxic components during the time frame in which the treatment of the withdrawn cells takes place. By substantial amounts is meant those amounts sufficient to significantly impair the effects of the treatment. In particular, the plasticizer commonly used in blood bags is such a toxic component.

Yet another aspect of the invention includes a step of preparing antigen presenting cells, particularly dendritic antigen presenting cells, and generally cells that are autologous to the patient undergoing treatment, and mixing such antigen presenting cells with the photopheresed cells prior to their reinfusion into the patient.

In a related aspect of the invention, the photopheresed cells are reinfused in the presence of or in combination with the administration of an immunomodulatory agent. Suitable immunomodulatory agents include cytokines, and interferon-α, FLT-ligand, GM-CSF, IL-4, TNF-α, FGF and IL-12.

Another aspect of the invention relates to compositions comprising a container for blood or treated leukocytes that does not contain or leach substantial amounts of a plasticizer and cells that have been incubated for at least about eight hours following their treatment with a photoactivatable agent. Compositions involving cells treated for longer incubation times, as noted above, also are contemplated.

In yet another aspect, the invention relates to compositions comprising populations of disease effector cells that have been treated as described above. Generally such populations will include normal cells as well. In particular, leukocytes disease-effector cells, such as T-cells, B-cells or macrophages are present. Particular disease-effector cells such as lymphoma cells, and in particular, cutaneous T-cell lymphoma cells are involved.

### BRIEF DESCRIPTION OF THE DRAWING FIGURES

FIG. 1 shows graphical data that demonstrates the antitumor response of vaccinations against tumor growth using a therapeutic mixture comprising irradiated 2B4.11 tumor cells and dendritic cells.

FIG. 2 shows the impact of 8-MOP/UVA treatment on MHC Class I expression and the effects of emetine.

FIG. 3 shows the enhanced level of induction of Class I MHC molecules by 8MOP.

FIG. 4 shows the peptide dependence of 8-MOP induced class I increase.

FIG. 5 shows a quantitative comparison of Class I peptides detected on C1R B cells in various cell culture containers, following photopheresis.

### DETAILED DESCRIPTION OF THE INVENTION

The methods and compositions of the present invention are used to treat a patient or subject that has a disease that is mediated by or is conditioned upon the presence of “disease effector” cells. These cells can be distinguished from other cells in the body on the basis of their display of cell membrane antigens, referred to above as “disease-associated antigens,” corresponding in a simplified sense to the “license plates” on cars. In a similar sense to the colors, numbers and letters on the license plate, some disease-associated antigens are unique and others are shared with various groups such as family members or others of similar ethnic extraction. These antigens can, under conducive circumstances, be identified by immune system cells that, directly or indirectly, then target other members of the group of disease-effector cells for destruction, controls on growth and/or other effects. Examples of disease effector cells include, but are not limited to, T cells, B cells, and/or infected white blood cells, such as virally or bacterially infected cells.

The present invention is based upon a continuing investigation of photopheresis, a procedure now in use in more than 100 centers worldwide. It has been a standard therapy for the leukemic phase of cutaneous T cell lymphoma (CTCL) for the past decade, and an estimated 50,000 treatments having been performed. As discussed above, the treatment involves the extracorporeal exposure of leukapheresed leukocytes to ultraviolet A (UVA) activated 8-methoxypsoralen.

Also as discussed above, it has been recognized, for the past decade, that reinfusion of 8-MOP-exposed leukemic leukocytes to immunocompetent CTCL patients essentially vaccinates them against their malignant cells, leading to a CD8⁺ T cell anti-tumor response. In approximately 25% of these subjects, longstanding remissions and potentially cures are obtained. Side effects have been extremely limited and have required cessation of photopheresis in fewer than 1% of subjects. These side effects have most commonly included transient hypotension, due to the transient depletion in intravascular volume, which has been reversible on reinfusion of the blood, occasional difficulty in cannulating the antecubital vein, fever for a few hours following infusion of treated cells and elevation of serum uric acid, correctable with oral allopurinol administration.

In photopheresis for leukemic CTCL, less than 5% of the malignant population is chemically altered ex vivo and returned to the patient. The ensuing immunologic reaction, “vaccination,” is sufficient, in responders, to lead to destruction of some or all of the other 95% of the malignant cells. Therefore, it has long appeared that the procedure immunizes against tumor antigens shared by all of the malignant cells in a particular patient. The principal difficulty associated with the therapy has been that, in a majority of patients, results have been either incomplete or temporary. Since leukemic CTCL is a fatal disorder, not effectively treated by conventional chemotherapy or radiotherapy, these patients are at serious risk of death when photopheresis inadequately controls the disease.

Until the underlying mechanism of action was better understood, it was not possible to improve the efficiency of the procedure. However, important aspects of the underlying mechanism now have been elucidated, and improved treatment methods have been rationally developed. The central unanswered question, until recently, has been by what mechanism the tumor cells become more immunogenic, following exposure to activated 8-MOP. It has been learned, from a series of experimental models and cellular studies, that exposure of malignant leukocytes and dendritic antigen presenting cells (DAPCs) to photoactivated 8-MOP leads to a very substantial increase in the display of tumor antigens at the cell surface and their transfer to the DAPCs.

The disease-associated antigens, or tumor antigens in the case of CTCL, are displayed in the form of small (8-10 amino acid) peptide fragments of tumor-specific protein components of the clone-specific T cell receptor. They are displayed at the cell surface in the context of MHC Class I glycoproteins. This increase in MHC-peptide antigen complexes peaks at 300% at about 24 hrs, as compared to being only approximately 20% or less at about 2 hrs. We now believe that photopheresed CTCL cells under current FDA-approved protocols apparently are returned too early to the patient (currently at about 2 hours instead of, for example, about 24 hrs). It is contemplated that a preferred period of incubation before photopheresed cells are returned to a patient is at least about 6 hours or about 8 hours, preferably in the range of about 8 to 30 hours, more preferably in the range of about 20 to 26 hours, and most preferably about 24 hours. For a particular patient or particular type of disease-effector cell or disease-associated antigen, the optimum time period may vary, and can be optimized by the skilled artisan. In general, too short a time period may not permit sufficient amounts of disease-associated antigen to be displayed on the cell membrane and too long a time period may result in the death and lysis of the photopheresed cells.

It is contemplated that a variety of diseases can be treated using the improved methods of the present invention including, but not limited to, leukemia, lymphoma, autoimmune disease, graft versus host disease, and transplanted tissue rejection. In these conditions, the disease-associated antigen typically is a peptide that is associated with (binds to) an MHC Class I site, an MHC Class II site or, to a heat shock protein that is involved in transporting peptides to/from MHC sites (i.e., a chaperone). Other conditions that can be treated using the present methods include instances in which a disease-associated antigen, such as a viral or bacterial peptide, is expressed on the surface of an infected white blood cell, usually in association with an MHC Class I or Class II molecule.

In general, a patient's enhanced immune response to photopheresed disease effector cells is mediated by a class of leukocytes known as dendritic cells. See, Featherstone, Lancet (1997) 349(9068):1820. Such dendritic cells, preferably peripheral blood dendritic cells, or other antigen presenting cells, can be removed from a subject and cultured in vitro. The cultured dendritic cells can be added to an extracorporeal treated blood sample, such as that described above, to increase the degree of immune response obtained. In addition, cultured dendritic cells can be added in combination with a subunit vaccine to facilitate and increase vaccine presentation. Further, cultured dendritic cells can be used as a booster to prolong the effectiveness of methods that rely on the induction of an immune response, such as in photopheresis and vaccination protocols.

With respect to the containers in which disease-effector cells are photopheresed and/or incubated before they are returned to a patient, the particular container or its composition is not critical. Rather, the container should not contain or leach compounds that substantially or inappropriately interfere with the transport and cell membrane display of disease-associated antigens and/or MHC molecules, or those compounds whose toxicity causes the death of inappropriate numbers of treated cells. Thus, for example, the photopheresed cells preferably are incubated in a container that does not leach substantial amounts of plasticizer. In other words, the container should either not contain a plasticizer or not leach its plasticizer into the incubating cells or should leach plasticizer at levels that do not significantly or substantially impede the intended effects of the photopheresis process.

As noted above, various alternative plastic formulations have been developed for blood, dialysis and IV bags and associated tubing. Such plastic compounds that have been described in the medical literature include di-n-decyl phthalate plasticized polyvinyl chloride and flexible polyolefin. Glass containers, although more difficult to work with in some respects also would be appropriate.

The specific examples presented below show practical applications of the present invention, as related to cell incubation times and to the use of blood bags that do not leach plasticizers. These examples are illustrative only and are not intended to limit the scope of the invention. For example, it is contemplated that various other agents, particularly immunomodulatory agents can be coadministered with photopheresed disease-effector cells, either separately to a patient or by adding such agents to the cells prior to their reinfusion. In this regard, the administration of α-interferon may be beneficial during photopheresis in patients with advanced CTCL. Dippel et al., Lancet (1997) 350(9070):32-33. Various other additional modifications to the protocols described below can be made by the skilled artisan in order to enhance the efficacy of the patient's immune response. See, e.g., Nossal, Lancet (1997) 350(9087):1316-1319; Osanto, Oncologist (1997) 2:284-299. Specifically, other therapeutic agents that could be coadministered to a subject include one or more of FLT-ligand, GM-CSF, IL-4, TNF-α, FGF and IL-12.

Also, it expressly is contemplated that a variety of temperatures can be used during the incubation period, although about 37° C. generally is preferred. Similarly, agitating the cells during their incubation also is preferred, particularly when antigen presenting cells are also added to the treated disease-effector cells.

### EXAMPLES

### Example 1

### Experimental Clinical Protocol for Treatment of CTCL

The treatment procedure is essentially the same as the protocols currently approved by the FDA, except that the patients' leukapheresed and photopheresed blood is incubated for about 20 to 28 hours, more preferably about 22 to 26 hours and most preferably about 24 hours before being reinfused.

Patients receive either oral 8-MOP (0.6 mg/kg) or intravenous 8-MOP directly into the photopheresis apparatus, to yield a concentration of 50-200 ng/ml of drug. Next, the blood is leukapheresed to obtain a buffy coat and then passed through the contiguous closed circuit ultraviolet A exposure device, delivering a desired level of about 1-2 joules/cm² of ultraviolet A energy. In this manner, about 1 to 100 molecules of 8-MOP are induced to bind covalently to thymines of the leukocyte DNA and to aromatic amino acids of proteins. The treated leukocyte fraction, comprising a total volume of approximately 250 cc, combined with about 500 cc of saline, is then sequestered in a standard blood bank bag, as has been typical for the photopheresis procedure.

At this point, a single variation from the standard treatment is initiated. Instead of returning the patient's cells and the saline to the patient, the bag is detached from the apparatus. The cells are then placed in a CO₂ incubator at 37° C. for about 24 hours and are then returned to the subject, by intravenous infusion, the following day. Although it has been demonstrated that, under these conditions, in excess of 98% of the cells remain viable and free of contamination, certain precautions will be taken when the infusion is initiated as discussed below.

At first, only about 10 ml of cell suspension may be administered and the patient is assessed for ten minutes for any adverse immediate reactions, such as fever, chills or hypotension, which might occur in the unlikely circumstance in which the suspension has been contaminated and contains, e.g., bacterial or fungal endotoxin. After the ten minute observation period, the remainder of the cell suspension is intravenously infused, over approximately 30 to 60 minutes, under careful supervision.

The treatment schedule is two successive days, at monthly intervals, as has been standard for photopheresis. Cellular reinfusion occurs on day 2, following the second withdrawal of blood in this monthly cycle, and again on day 3 when no additional blood is withdrawn for treatment. Accordingly, the reinfused cells are not reexposed to additional ultraviolet energy.

In a contemplated variation on this protocol, cells obtained and photopheresed on day 1 are incubated overnight as described above to maximize Class I display and then added to the leukocyte fraction obtained from cells withdrawn from the patient on day 2. In this alternate protocol, the cells obtained from the first photopheresis treatment and those obtained from day 2 (without overnight incubation) are allowed to mix together from about 0.5 to about 5 hours or more and then reinfused together into the patient. The use of this protocol is appropriate when it is judged that sufficient Class I MHC increase has resulted from the treatment of the leukocyte fraction obtained on day 1 and when the antigen presenting capacity of the cells drawn on day 2 is satisfactory. This protocol permits the shortening of the total duration of the therapy from three to two days, and may also, in some patients effectively initiate a desired immune response.

Clinical response in CTCL is assessed in three ways. First, the widespread cutaneous involvement in CTCL patients is characterized in standard fashion and by skin biopsies, as is customary. These skin biopsies are assessed by routine histopathologic examination, as well as for subsets of infiltrating T cells using a battery of monoclonal antibodies, as has been standard. The blood is similarly assessed with the monoclonal antibodies and cytofluorography, with the percentage and absolute number of malignant cells being determined through the use of T cell receptor family specific antibodies which recognize selectively the malignant cells. Finally, the capacity of induced anti-tumor CD8⁺ T cells to recognize and lyse the patient's malignant T cells is determined.

If the patient's clinical response and confirmatory laboratory determinations are positive, and if no limiting adverse effects have been identified, the therapy is continued on a monthly basis, until maximal. At that time, as has been standard, the frequency of the treatment is tapered progressively to one cycle on alternate months, then every third month and every fourth month, before stopping the photopheresis.

The patients are assessed for side effects, including fever, serum uric acid levels, other routine blood chemistries and hematologic parameters, normal T cell subsets, and anti-nuclear antibodies. A complete medical history and examination, including peripheral lymph nodes, liver and spleen, is performed monthly, prior to initiation of the treatment cycle. Follow-up examination, 6-months after cessation of therapy, is also performed.

### Example 2

### Treatment of Two CTCL Patients with Incubated Cells

After preparation of leukapheresed and photopheresed cells according to Example 1, the blood bags containing treated cells were placed in a locked incubator committed solely to this purpose; and only one patient's cells at a time were kept in the incubator.

Two patients with otherwise advanced therapeutically resistant CTCL were treated according to the protocol in the foregoing example. Both had intractable leukemic CTCL, and had been receiving photopheresis for their CTCL, with diminishing success, for 8 and 10 years, respectively. At the outset of treatment, malignant cells comprised more than 90% of the T cells in Patient 1's blood and 63% in Patient 2's blood. After just the first month and first cycle of photopheresis treatments, a favorable response was observed in both, in the absence of identifiable side effects. Specifically, in one of those subjects, a twenty-five percent reduction in the number of circulating malignant T cells, which previously had been increasing, was noted. In the other patient, an 18% decrease in the number of circulating malignant cells was noted, along with a diminution in the number of cells infiltrating broad expanses of skin, which had been worsening, were both observed.

### Example 3

### Demonstrated Efficacy of Photopheresis/Dendritic Cell Treatment

To demonstrate the effectiveness of combining extracorporeal treatment of disease effector cells and the addition of dendritic cells, murine 2B4.11 tumorigenic T cells were treated as described in Edelson, PCT Application Serial No. WO97/34472 (1997) using 8MOP and UVA. The 2B4.11 tumor cells were derived by hybridizing or combining two original cell types: normal AKR mouse T cells with BW5147 mouse malignant T cells. The AKR parental cell provides specific antigens, including a T cell receptor, which can apparently serve as a tumor specific antigen, to be targeted by an induced anti-tumor immunologic reaction. The BW5147 parental cell contribution permits the 2B4.11 cells to act like a cancer cell, dividing without check until they kill the animal.

Following 8-MOP/UVA treatment of the tumor cells, dendritic cells were added to the treated cell mixture. Two groups of 5 test mice were vaccinated with 5 million 2B4.11 cells that had been inactivated with 8-MOP/UVA treatment and mixed with dendritic cells (DAPC). The 8-MOP/UVA irradiated tumorigenic cells were shaken overnight with 200,000 dendritic cells (a 25 to 1 ratio), to maximize cell-to-cell contact between the DAPCs and the 2B4.11 cells. One group of cells (irradiated 2B4.11 plus DAPCs) was incubated at 23° C., to maximize stability of empty class I MHC molecules on the DAPCs. The other group of cells was incubated at 37° C., to maximize normal cellular metabolism. The combined irradiated 2B4. 1 /DAPC cell mix was injected into the test mice one week prior to challenging the animals with viable, tumorigenic 2B4.11 cells.

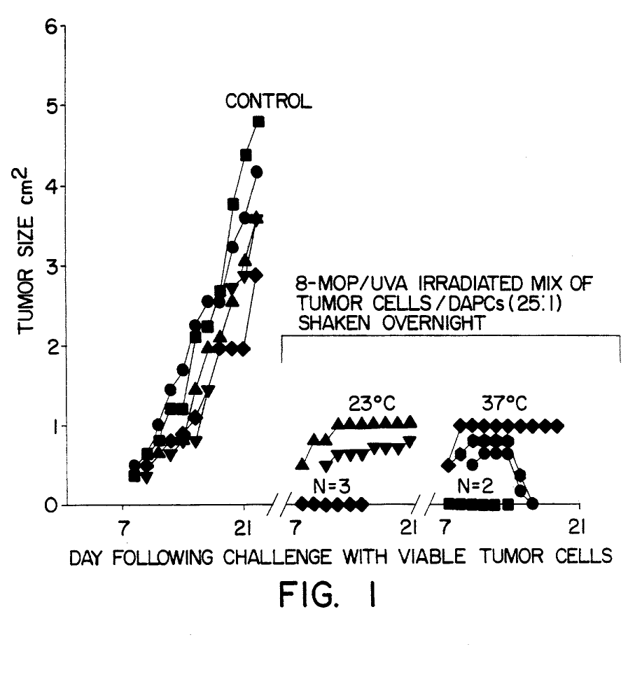

In FIG. 1, reading from left to right, tumor growth is first depicted in five control mice, which received only skin injections of tumor cells on day 0 and no anti-tumor vaccination. All of these mice had visible tumors by day 8, which progressively grew until day 21, the last day of observation in these experiments. Of the vaccinated mice, all ten (both groups that received DAPCs) developed tumors that grew more slowly than those in the control mice, or did not grow at all. Three of the mice receiving the 23° C. cell mix and two of the mice receiving the 37° C. cell mix did not grow tumors at all. The other two mice in the 23° C. group had small tumors which stopped enlarging after day 11. One of the other mice in the 37° C. group also had a very small tumor which stopped growing by 20 day 11. Of great interest, two of the other mice in the 37° C. group developed small, slowly growing tumors, which then completely resolved.

This data demonstrates that direct contact between 8-MOP/UVA irradiated tumorigenic cells and DAPCs leads to formation of an effective cellular vaccine, which not only prevents or slows tumor growth, but reverses growth of certain tumors. FIG. 1 demonstrates that the combination of genetically identical dendritic antigen presenting cells (DAPCs) plus 8-MOP/UVA pretreated murine 2B4.11 tumorigenic T cells constitutes an effective vaccine against the specific tumor. It has previously been shown that inoculation of mice with the tumorigenic 2B4.11 cells kills the mice within 40 days, unless the animals have been successfully vaccinated against the tumor. Alternatively, the antigen loaded dendritic cells can be isolated following mixing. Further, a membrane partition, for example a 0.45 micron filter, can be placed between the dendritic cells and the disease effector cells to allow passage of the antigens to the dendritic cells but keeps the two cell populations separated.

### Example 4

### Modified Photopheresis/Dendritic Cell Treatment

Following 8-MOP/UVA treatment of the tumor cells as described in Example 3, dendritic cells are added to the treated cell mixture in a ratio of tumor cells to dendritic cells of about 25 to 1 ratio. The 8-MOP/UVA irradiated tumorigenic cells together with the dendritic cells are shaken overnight for about 24 hours to optimize the expression of MHC Class I peptides and tumor-associated antigen on the tumor cell membranes. A group of 5 test mice is vaccinated with 5 million 2B4.11 cells that have been inactivated with 8-MOP/UVA treatment. The irradiated 2B4.11 cell mix is injected into the test mice one week prior to challenging the animals with viable, tumorigenic 2B4. 11 cells. Compared with control animals, the vaccinated mice exhibit a significant decrease in tumor size.

A similar experiment is conducted in which the photoinactivated tumor cells are also incubated for about 24 hours in the presence of DAPCs to enhance the transfer of the tumor specific antigens to the DAPCs. The mixture of cells inactivated with 8-MOP/UVA and the DAPCs treatment are injected into the test mice one week prior to challenging the animals with viable, tumorigenic 2B4.11 cells. Again, as compared with control animals, the vaccinated mice exhibit a significant decrease in tumor size

### Example 5

### Demonstrated Increase in MHC Expression Following Photopheresis

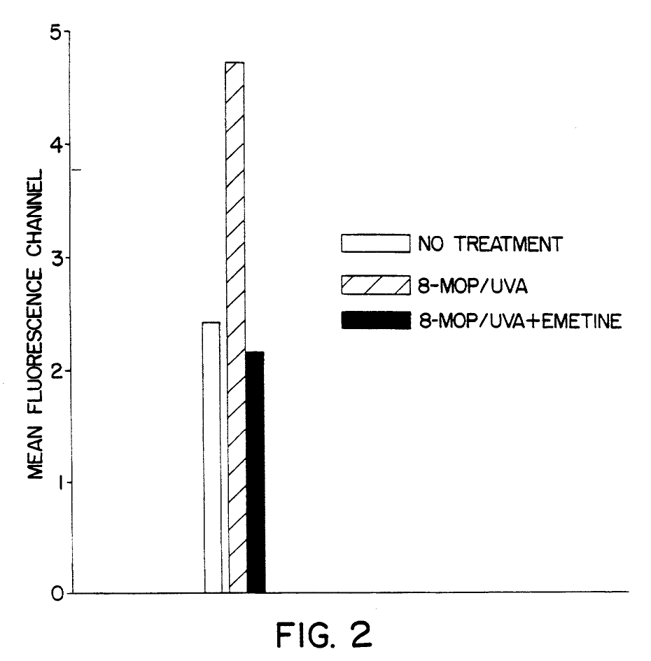

FIG. 2 shows the impact of 8-MOP/UVA on Class I expression. Mean fluorescence channel measurements permit the quantification of the amount of Class I protein on the cell surface, as identified with a fluorescent antibody against the Class I protein. Normally, at least 200,000 Class I molecules are displayed, as shown by a value of 2.4 in the control cell population. After exposure to 8-MOP/UVA (1 joule per cm² of UVA and 200 ng/ml of 8-MOP) and incubation for about 18 hours, Class I molecule expression about doubles. Since this massive increase in Class I expression is prevented by emetine, as also shown in FIG. 2, it therefore results from new protein synthesis.

### Example 6

### Increased Peptide Loading by 8-MOP of Surface Class I Molecules

In order to evaluate the enhanced immunogenicity of 8-MOP treated CTCL cells, a series of human lymphoblast lines was derived. The C1R B lymphoblastoid line, which in its native state expresses no HLA-A or HLA-B surface Class I and only a minute amount of HLA-C molecules was transduced with the Class I B27 allele. This modified cell population, with nearly all of its surface Class I molecules being B27, was exposed to 8MOP and incubated overnight.

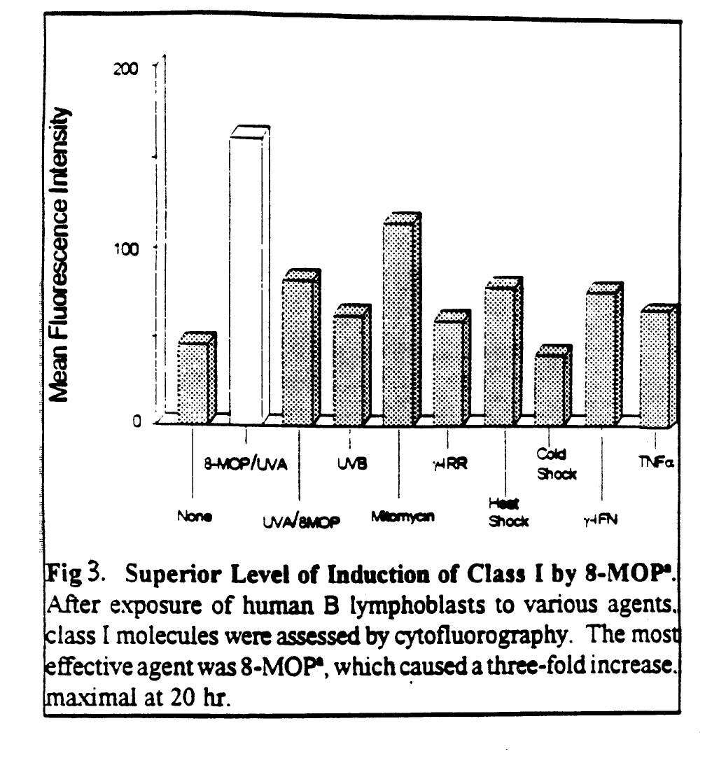

Class I expression, shown in FIG. 3 was assayed using labeled W6/32 monoclonal antibody that recognizes human Class I antigens, and was found to have increased approximately 3-fold over background, reaching peak levels at 20 hours after exposure to optimal levels of 8-MOP. When UVA was administered before the addition of 8-MOP, therefore not photoactivating the drug, only a minor increase in Class I expression was noted. Other pharmacologic and physical agents, including, ultraviolet B, γ-irradiation, γ-interferon, TNF-α and mytomycin C had either no or a more limited impact. These data show that 8-MOP alone augments the display of Class I molecules.

### Example 7

### Antigenic Peptide Dependence on Surface Class I Molecules

To determine if the Class I MHC molecules induced in Example 5 remained functional, i.e., could be loaded with a known B27 allele-specific peptide, iodinated peptide was added under varied conditions. See, generally, Anderson et al., J. Immunology (1993)151:3407-3419 The amount of peptide bound was determined by immunoprecipitation with an antibody (4E) specifically reactive with B27. Gentle acid pretreatment (one minute at pH 3.3) of the transduced B lymphoblasts, to dissociate class I heavy and light chains, followed by reconstitution of Class I with β-2 microglobulin was used as a positive control, because this procedure empties virtually all surface Class I molecules. It was found that the Class I molecules induced on transduced C1R B cells exposed to 8-MOP bound approximately 3-fold more allele-specific peptide than did the untreated cell line control, an increase in excess of 10,000 functional Class I molecules per cell. This is considered to be about a log more than would be needed to initiate an immune response.

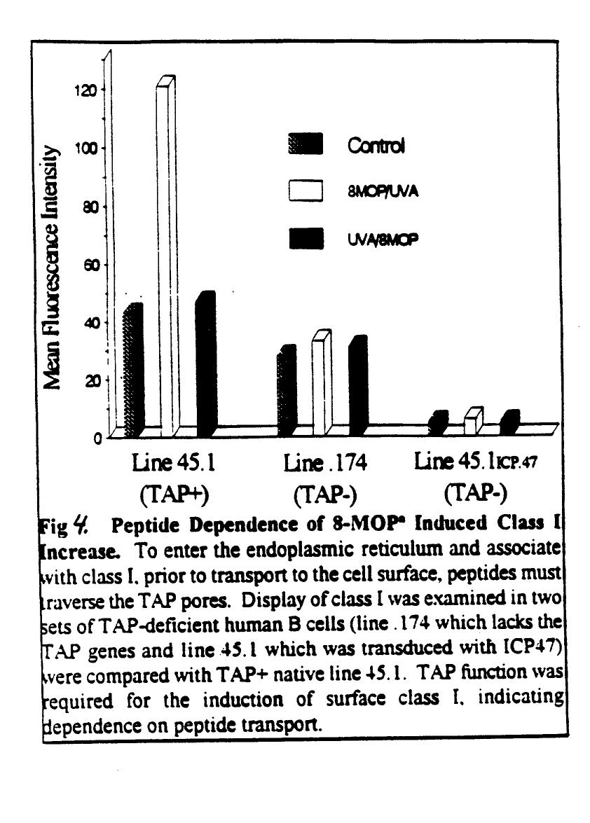

Next, it was determined that the 8-MOP-induced increase in surface Class I molecules is dependent on peptide transport across the endoplasmic reticulum through the transporter associated with peptide processing (TAP) pores. This was demonstrated in human B lymphoblasts that either lacked the TAP genes or had them functionally blocked by transduced ICP47. As shown in FIG. 4, under both of these conditions, the 8-MOP induced increase in Class I molecules was prevented. The increased immunogenicity of 8MOP treated disease-effector cells was thus shown to involve the augmented catabolism of proteins, leading to the generation of small peptides that are then transported to Class I molecules in the endoplasmic reticulum and then on to the cell surface where they associate with the Class I molecules.

### Example 8

### Use of Blood Bags without Plasticizers

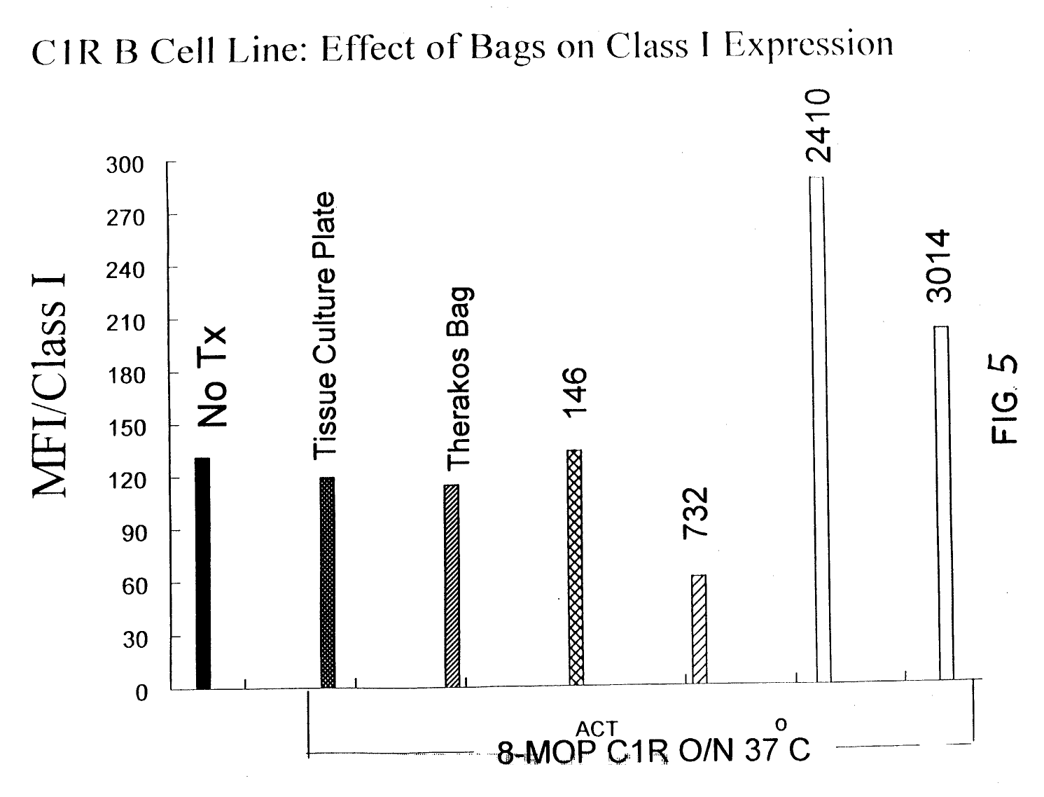

FIG. 5 shows a quantitative comparison of the number of Class I molecules on the surface of C1R B cells that were incubated for about 24 hours at 37° C. in various containers. Over this time period, the inhibition of Class I MHC expression became evident, caused by the plasticizer leached out of standard photopheresis blood bags (indicated in FIG. 5 as the “Therakos Bag”) and the other bags indicated by Numbers 146, 732 and 3014 (manufactured by Fenwal®) in the figure. In contrast, the Fenwal® Amicus™ Apheresis kit bag identified in the figure with Number 2410 does not contain leachable plasticizers and supported a very substantial increase in cell surface Class I molecules.

In the foregoing experiment, C1R human B lymphoblasts, cells molecularly engineered so that they display a readily studied B27 Class I protein complex, were exposed to photoactivated 8-MOP in the presence of various plastic containers. The mean fluorescence intensity was measured in a cytofluorimeter, using monoclonal antibodies specific for the B27 Class I complex. As shown in FIG. 5, exposure of C1R cells to photoactivated 8-MOP in the 2410 bag more than doubled their Class I MHC level, in comparison to untreated controls or to cells exposed during this period to plastics with the deleterious plasticizers (plastic tissue culture plates, Therakos bag, or bags Number 146 and 732. Another plasticizer-containing bag (Number 3014) was also inhibitory of the Class I MHC display, but no to the same extent as the others. The difference between the level of Class I MHC display in the presence of bag Number 2410 and that of all other plastics was highly significant. These results clearly reveal that a bag lacking deleterious plasticizers is far more supportive of the desired increase in expression of Class I major histocompatibility complexes, with which potentially antigenic peptides are associated. These data show that selecting the proper type of container in which the photopheresed leukocytes are incubated is of major importance in optimizing the immunogenicity of treated disease-effector cells.

It should be understood that the preceding is merely a detailed description of certain preferred embodiments. It therefore should be apparent to those of ordinary skill in the art that various modifications and equivalents can be made without departing from the spirit and scope of the invention. All references, patents and patent publications that are identified in this application are incorporated by reference in their entirety.

1. A method to enhance the level of expression of MHC molecules on the cell membrane of cells withdrawn from a subject, comprising the steps of treating the cells with a photoactivatable agent for a sufficient time to allow the agent to enter the cells, photoactivating the agent contained within the cells, and incubating the cells for at least about eight hours.

2. A method to enhance the level of expression of at least one disease-associated antigen on the cell membrane of cells withdrawn from a subject, the antigen being bound to MHC molecules on the cell membrane, comprising the steps of treating the cells with a photoactivatable agent for a sufficient time to allow the agent to enter the cells, photoactivating the agent contained within the cells, and incubating the cells for at least about eight hours.

3. The method according to any of claims 1 and 2, wherein the cells are incubated for a period of about 8 to about 30 hours.

4. The method according to claim 3, wherein the cells are incubated for a period of about 20 to about 26 hours.

5. The method according to claim 3, wherein the MHC molecules are selected from the group consisting of Class I, Class II and both Class I and Class II molecules.

6. The method of claim 5, wherein the treated cells comprise disease-effector cells.

7. The method of claim 6, wherein the disease effector cells further comprise leukocytes.

8. The method of claim 7, wherein the leukocytes are selected from the group consisting of T-cells, B-cells and macrophages.

9. The method of claim 8, wherein the leukocytes are T-cells.

10. The method of claim 9, wherein the T-cells further comprise lymphoma cells.

11. The method of claim 10, wherein the lymphoma cells further comprise cutaneous T-cell lymphoma cells.

12. The method of claim 6, wherein at least one disease-associated antigen is bound by the MHC molecules on the disease-effector cells.

13. The method of claim 12, wherein the disease-associated antigen is selected from the group consisting of viral antigens, bacterial antigens, transplant antigens and tumor specific antigens.

14. The method of claim 13, wherein the tumor specific antigen is a peptide derived from a T cell antigen-binding cell surface receptor.

15. The method of claim 5, wherein the photoactivatable agent is 8-MOP.

16. The method of claim 5, wherein the photopheresed cells are incubated in a container that does not leach substantial amounts of plasticizer.

17. The method of claim 5, comprising the further step of reinfusing the incubated cells into the subject.

18. The method of claim 17, wherein the level of MHC molecules on the incubated cells are substantially enhanced relative to the level of MHC molecules on cells incubated for only about two hours.

19. The method of claim 17, wherein the level of disease-associated antigens bound by the MHC molecules on the incubated cells are substantially enhanced relative to the level of disease-associated antigen bound by MHC molecules on cells incubated for only about two hours.

20. The method of claim 17, wherein antigen presenting cells are mixed with the photopheresed cells prior to their reinfusion.

21. The method of claim 17, further comprising the step of reinfusing the photopheresed cells in the presence of or in combination with an immunomodulatory agent.

22. The method of claim 21, wherein the immunomodulatory agent is a cytokine.

23. The method of claim 21, wherein the immunomodulatory agent is selected from the group consisting of interferon-α, FLT-ligand, GM-CSF, IL-4, TNF-α, FGF and IL-12.

24. A composition comprising a container that does not contain or leach substantial amounts of a plasticizer and cells that have been incubated for at least about eight hours following their treatment with a photoactivatable agent for a sufficient time to allow the agent to enter the cells, and then photoactivation of the agent.

25. The composition of claim 24, wherein the cells have been incubated for about 8 to about 30 hours.

26. The composition of claim 25, wherein the cells have been incubated for about 20 to about 26 hours.

27. The composition of claim 24, wherein the photoactivatable agent is 8-MOP.

28. The composition of any of claims 24 to 27, wherein the treated cells comprise disease-effector cells.

29. The composition of claim 28, wherein the disease effector cells further comprise leukocytes.

30. The composition of claim 29, wherein the leukocytes are selected from the group consisting of T-cells, B-cells and macrophages.

31. The composition of claim 30, wherein the leukocytes are T-cells.

32. The composition of claim 31, wherein the T-cells further comprise lymphoma cells.

33. The composition of claim 32, wherein the lymphoma cells further comprise cutaneous T-cell lymphoma cells.

34. The composition of claim 28, wherein at the disease-effector cells express MHC molecules and at least one disease-associated antigen is bound by the MHC molecules on the disease-effector cells.

35. The composition of claim 34, wherein the disease-associated antigen is selected from the group consisting of viral antigens, bacterial antigens, transplant antigens and tumor specific antigens.

36. The composition of claim 35, wherein the tumor specific antigen is a peptide derived from a T cell antigen-binding cell surface receptor.

37. A composition comprising the cells of any of claims 24 to 27.

38. The composition of claim 37, wherein the treated cells comprise disease-effector cells.

39. The composition of claim 38, wherein the disease effector cells further comprise leukocytes.

40. The composition of claim 39, wherein the leukocytes are selected from the group consisting of T-cells, B-cells and macrophages.

41. The composition of claim 40, wherein the leukocytes are T-cells.

42. The composition of claim 41, wherein the T-cells further comprise lymphoma cells.

43. The composition of claim 42, wherein the lymphoma cells further comprise cutaneous T-cell lymphoma cells.

44. The composition of claim 43, wherein at the disease-effector cells express MHC molecules and at least one disease-associated antigen is bound by the MHC molecules on the disease-effector cells.

45. The composition of claim 44, wherein the disease-associated antigen is selected from the group consisting of viral antigens, bacterial antigens, transplant antigens and tumor specific antigens.

46. The composition of claim 45, wherein the tumor specific antigen is a peptide derived from a T cell antigen-binding cell surface receptor.
